(19) United States
(12) Patent Application Publication
(10) Pub. No.: US 2012/0176038 A1
(43) Pub. Date: Jul. 12, 2012

(54) LIGHT EMITTING DIODE EMITTING DEVICE

(76) Inventors: Eun CHEON, Seoul (KR); Byunghak AHN, Seoul (KR)

(21) Appl. No.: 13/342,389

(22) Filed: Jan. 3, 2012

(30) Foreign Application Priority Data
Jan. 10, 2011 (KR) 10-2011-0002377

(51) Int. Cl. H05B 37/02

(52) U.S. Cl. 315/122

(57) ABSTRACT

The present invention relates to an LED emitting device.

An LED emitting device includes an LED channel having a plurality of LEDs coupled in series and a ground adjacent to the LED channel. A converter of the LED emitting device generates a voltage for activation of the LED channel by converting an input voltage. The LED emitting device includes a protection circuit determining whether the LED channel is grounded by sensing a current flowing to the ground.

### CROSS-REFERENCE TO RELATED APPLICATION

This application claims priority to and the benefit of Korean Patent Application No. 10-2011-0002377 filed in the Korean Intellectual Property Office on Jan. 10, 2011, the entire contents of which are incorporated herein by reference.

### BACKGROUND

(a) Field

Embodiments of present invention relates to a light emitting diode (LED) emitting device. More particularly, embodiments of present invention relates to an LED emitting device for protection of an LED emitting device when the LED emitting device is abnormally connected directly to ground.

(b) Description of the Related Art

A light emitting device using an LED (hereinafter, referred to as an LED emitting device) drives LEDs by supplying currents to the LEDs. Then, the LEDs emit beams having brightness corresponding to the currents. An LED light emitting device provides a predetermined intensity by making a predetermined current flow in each LED channel including a plurality of LEDs connected in series. An operation that the current is supplied to the LED channel for light emission is called turn-on and an operation that the current supply is blocked and thus light emission is stopped is canned turn-off.

The LED emitting device may include a plurality of LED channels, and controls a current flowing to each LED channel to be constant. Since the plurality of LED channels are coupled in parallel, each of the LED channel is applied with the same power voltage.

If the LED channel is electrically connected to a chassis that forms an outer side of the LED emitting device, a current flows to a chassis ground. In this case, a large amount of current flows to the LED channel so that the LED channel and the LED emitting device may be damaged.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of present invention have been made in an effort to provide an LED emitting device that can sense abnormal grounding of the LED emitting device.

An LED emitting device according to an embodiment of present invention the present invention includes an LED channel having a plurality of LEDs coupled in series and a ground adjacent to the LED channel. The LED emitting device includes a converter generating a voltage for activation of the LED channel by converting an input voltage and a protection circuit determining whether the LED channel is grounded by sensing a current flowing to the ground. The protection circuit includes: a resistor having a first end connected to the ground and a second end connected to the other ground; and a hysteresis comparator including a first input terminal connected to the first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic. The threshold reference voltage is determined according to a voltage generated when the LED channel is connected to the ground and thus a current flowing to the ground flows to the resistor.

An LED emitting device according to another embodiment of the present invention has an LED channel formed of a plurality of LEDs connected in series and a ground adjacent to the LED channel. The LED emitting device includes: a converter having a first inductor receiving an input voltage, and generating a voltage for activation of the LED channel by controlling switching operation of a switch that controls a current flowing to the first inductor; and a protection circuit determining whether the LED channel is grounded by sensing a current flowing to a second inductor coupled to the first inductor in an insulated manner.

The protection circuit includes a resistor connected in parallel to the second inductor and a hysteresis comparator comprising a first input terminal connected to a first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic.

The threshold reference voltage is determined according to a voltage generated when the LED channel is connected to the ground and thus a current flowing to the second inductor flows to the resistor.

The protection circuit includes: a photodiode coupled in parallel to the second inductor; a phototransistor forming an opto coupler with the photodiode; a resistor having a first end connected to the phototransistor and a second end connected to a predetermined bias voltage; and a hysteresis comparator having a first input terminal connected with the first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic

The threshold reference voltage is determined according to a voltage drop that occurs by a current flowing to the phototransistor when the LED channel is connected to the ground and thus the current flowing to the second inductor flows to the photodiode.

The present invention provides an LED emitting device that can sense abnormal grounding of the LED emitting device.

### BRIEF DESCRIPTION OF THE DRAWINGS

FIG. 1 shows an LED emitting device according to an exemplary embodiment of the present invention.

FIG. 2 shows the schematic diagram of the current regulator according to an exemplary embodiment of the present invention.

FIG. 3 shows an LED emitting device including a protection circuit according to another exemplary embodiment of the present invention.

FIG. 4 shows an LED emitting device including a protection circuit according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Further, in the specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

The present invention will be described more fully hereinafter with reference to the accompanying drawings, in which exemplary embodiments of the invention are shown.

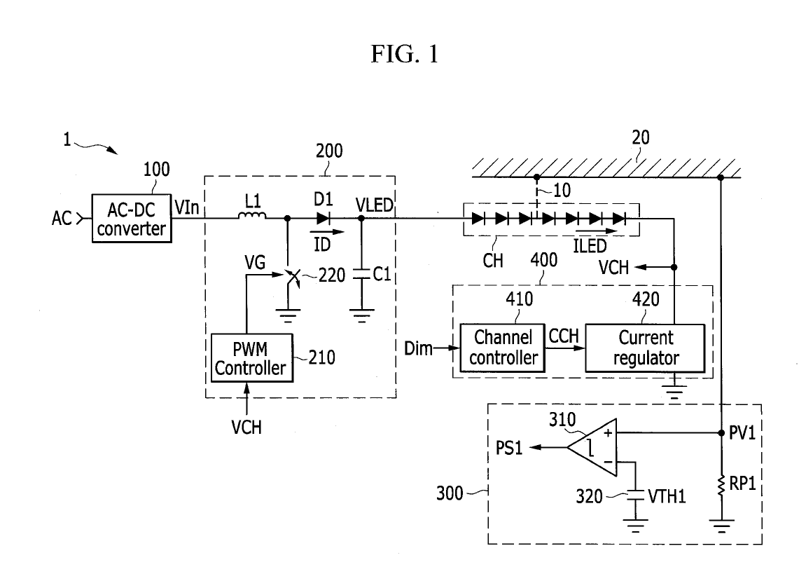

FIG. 1 shows an LED emitting device according to an exemplary embodiment of the present invention.

As shown in FIG. 1, an LED emitting device 1 includes an AC-DC converter 100, a converter 200, a protection circuit 300, a channel driver 400, and an LED channel CH.

The AC-DC converter 100 converts an AC input to a DC input voltage VIN (hereinafter, referred to as an input voltage).

The converter 200 generates a power voltage VLED by converting the input voltage VIN. The converter 200 according to the exemplary embodiment of the present invention is realized as a boost converter, but the present invention is not limited thereto. Since the power voltage VLED for driving of the LED channel CH is set to be higher than the input voltage VIN, the converter 200 is realized as the boost converter in the present exemplary embodiment.

The converter 200 includes an inductor L1, a PWM controller 210, a switch 220, a rectifying diode D1, and a capacitor C1.

A first end of the inductor L1 is connected to the input voltage VIN and a second end thereof is connected to an anode of the rectifying diode D1 and a first end of the switch 220. A second end of the switch 220 is grounded, and the switch 220 performs a switching operation according to a gate signal VG generated from the PWM controller 210.

A cathode of the rectifying diode D1 is connected to a first end of the capacitor C1 and the LED channel CH. A second end of the capacitor C1 is grounded, and a voltage charged in the capacitor C1 becomes a power voltage VLED.

During the turn-on period of the switch 220, a current flows to the inductor L1 by the input voltage VIN and power is charged to the inductor L1. During the turn-off period of the switch 22, the capacitor C1 and the LED channel CH are supplied with the current through the rectifying diode D1 by the power charged in the inductor L1.

The PWM controller 210 controls the switching operation of the switch 220 using a voltage VCH that is obtained by subtracting a voltage of the LED channel CH from the power voltage VLED. The PWM controller 210 controls the switching operation of the switch 220 using a difference between the channel voltage VCH and a predetermined reference voltage to maintain channel voltage VCH to be constant.

In the exemplary embodiment of the present invention, one LED channel is illustrated but the present invention is not limited thereto. That is, the LED emitting device may include a plurality of LED channels. In this case, the PWM controller 210 may receive a channel voltage of each of the plurality of LED channels and control the switching operation of the switch 220 according to the lowest voltage among the plurality of channel voltages.

In order to maintain a current flowing through the LED channel to be constant, the power voltage VLED should be sufficient enough to activate the LED channel. The channel voltage is a voltage obtained by subtracting a LED channel voltage from the power voltage VLED, and therefore it can be determined whether the power voltage VLED is sufficient enough for activation of the LED channel using the channel voltage.

Further, undesired power consumption may occur of the power voltage VLED is excessively high. Thus, the channel voltage is maintained with the reference voltage by controlling the switching operation of the switch 220 to thereby activate the LED channel and prevent unnecessary power consumption.

The LED channel CH exemplarily include seven LED elements, but the present invention is not limited thereto.

The channel driver 400 includes a channel controller 410 and a current regulator 420.

The channel controller 410 generates a channel control signal CCH that controls operation of the current regulator 420 according to a dimming signal Dim. The channel control signal CCH enables the current regulator 420.

The current regulator 420 controls a current (ILED) of the LED channel CH to be constant according to the channel control signal CCH.

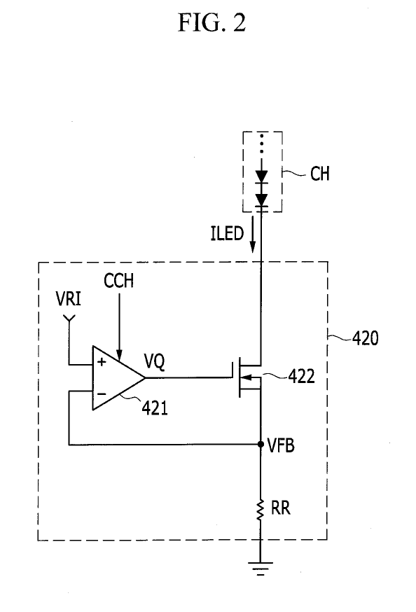

FIG. 2 shows the schematic diagram of the current regulator according to an exemplary embodiment of the present invention.

As shown in FIG. 2, the current regulator 420 includes an error amplifier 421, a NMOSFET 422, and a resistor RR.

The error amplifier 421 starts operation by being enabled by the channel control signal CCH. The error amplifier 421 generates a gate signal VQ to equalize a feedback voltage VFB input to the inversion terminal (−) and a reference voltage VRI. The NMOSFET 422 is connected according to the gate signal VQ such that the current (ILED) is controlled to be constant.

When the current ILED is decreased and the feedback voltage VFB is decreased and thus the feedback voltage VFB is not equal to the reference voltage VRI, the gate signal VQ is generated in a direction for offsetting the difference between the feedback voltage VFB and the reference voltage VRI. For example, when the feedback voltage VFB becomes higher than the reference voltage VRI, the gate signal VQ is decreased and thus the connectivity of the NMOSFET 422 is decreased, thereby causing decrease of the current ILED. On the contrary, when the feedback voltage VFB is lower than the reference voltage VRI, the gate signal VQ is increased and thus the connectivity of the NMOSFET 422 is increased so that the current ILED is increased.

With such a method, the feedback voltage VFB is controlled to be equal to the reference voltage VRI such that the current ILED is constantly maintained.

The protection circuit 300 detects abnormal grounding of the LED channel CH. As an example of the abnormal grounding, the LED channel CH is grounded to the chassis 20 in the exemplary embodiment of the present invention. However, the present invention is not limited thereto, and any configuration in which the LED channel CH is abnormally grounded may be applicable.

The protection circuit 300 is connected to the chassis 20 and determines that that LED channel. CH is abnormally grounded when a current flowing to the chassis 20 exceeds a predetermined threshold range.

The protection circuit 300 includes a hysteresis comparator 310, a reference voltage source 320, and a resistor RP1.

The resistor RP1 includes a first end connected to the chassis 20 and a second end being grounded.

The reference voltage source 320 supplies a threshold reference voltage VTH1 that corresponds to the threshold range.

The hysteresis comparator 310 includes a non-inversion terminal (+) to which a voltage PV1 generated in the resistor RP1 is input and an inversion terminal (−) to which the threshold reference voltage VTH1 is input.

When the threshold reference voltage VTH1 is higher by a voltage PV1 than the highest value of a predetermined threshold voltage range that is determined according to the hysteresis characteristic of the threshold reference voltage VTH1, a high-level protection signal PS1 is generated. When the threshold reference voltage VTH1 is lower by the voltage PV1 than the lowest value of the threshold voltage range, a low level protection signal PS1 is generated. When the voltage PV1 is included between the highest and lowest values of the threshold voltage range, the protection signal PS1 does not experience level change.

The hysteresis comparator 310 is used to prevent level change of the protection signal PS1 due to a ripple component of the voltage PV1.

In FIG. 1, the current ILED flows to the chassis 2 when a part of the LED channel CH is abnormally grounded to the chassis 20. In the drawing for description of the embodiment of the present invention, the abnormal grounding is marked as dotted line “10”. However, the present invention is not limited thereto. The abnormal grounding may occur in at least one spot in the LED channel CH, and a target of the grounding may include not only the chassis but also a configuration related to the grounding among other configurations adjacent to the LED channel CH.

When the abnormal grounded state is continued, the channel voltage VCH is maintained with the grounding voltage so that the PWM controller 210 activates the switch 220 with the maximum duty. Since the channel voltage VCH is not increased even through the switch 220 is activated with the maximum duty while the LED channel CH is in the abnormally grounded state, the converter 200 may be damaged due to excessive operation and the LED channel CH may be damaged due to an excessive current.

In the exemplary embodiment of the present invention, when a current flowing to the chassis 20 is generated, the current flowing to the chassis 20 flows to the resistor RP1 so that the voltage PV1 is generated. When the voltage PV1 becomes higher than the highest value of the threshold voltage range, a high-level protection signal PS1 is generated.

In the exemplary embodiment of the present invention, it is determined that protection operation is required when the protection signal PS1 has high level. For the protection operation, the AC-DC converter 100 may stop operation to block the input voltage VIN. Further, the converter 200 may also stop operation to block a current supplied to the LED channel CH through the rectifying diode D1. The two protection operations may be simultaneously or selectively performed.

In the exemplary embodiment referring FIG. 1, the protection signal is generated by sensing the current flowing to the chassis 20, but the present invention is not limited thereto. Any protection operation that can sense an excessive current flowing to the LED channel CH due to abnormal grounding of the LED channel CH is applicable.

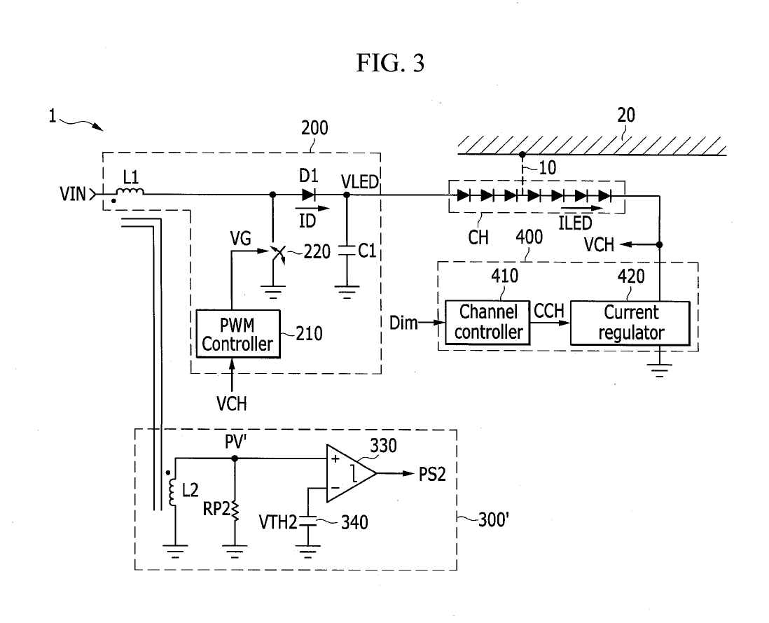

Hereinafter, another exemplary embodiment of the present invention will be described with reference to FIG. 3.

FIG. 3 shows an LED emitting device including a protection circuit according to another exemplary embodiment of the present invention. Parts that are the same as the previously described exemplary embodiment have the same reference numerals. Parts that are the same as the previously described exemplary embodiment will not be described.

As shown in FIG. 3, a protection circuit 300′ according to the other exemplary embodiment of the present invention is not connected with a chassis 20, and an LED channel CH is abnormally grounded to the chassis 20 so that it does not directly sense a current flowing to the chassis 20.

The protection circuit 300′ according to the other exemplary embodiment of the present invention senses an excessive current flowing to the LED channel CH due to abnormal grounding of the LED channel CH to the chassis 20. When the LED channel CH is abnormally grounded to the chassis 20, a load of an output terminal of a converter 200 is significantly reduced so that a current flowing to an inductor L1 is significantly increased.

The protection circuit 300′ senses a current flowing to an inductor L2 coupled to the inductor L1 in an insulated manner to sense the significant increase of the current flowing to the inductor L1.

The protection circuit 300′ includes the inductor L2, a resistor RP2, a hysteresis comparator 330, and a reference voltage source 340.

The inductor L2 is coupled with the inductor L1 in an insulated manner with a predetermined turn ratio. The current flowing to the inductor L1 is converted according to the turn ratio and then generated in the inductor L2.

The current generated in the inductor L2 flows to the resistor RP2, and a voltage PV2 is generated in the resistor RP2.

The reference voltage source 340 supplies a threshold reference voltage VTH that corresponds to the voltage PV2 generated by the current of the inductor L2, generated according to the current flowing to the inductor L1 when the LED channel CH is in the abnormally grounded state.

The hysteresis comparator 330 includes a non-inversion terminal (+) to which the voltage PV2 is input and an inversion terminal (−) to which the threshold voltage VTH2 is input.

When the threshold reference voltage VTH2 is higher by a voltage PV2 than the highest value of a predetermined threshold voltage range determined according to a hysteresis characteristic of the hysteresis comparator 310, a high-level protection signal PS2 is generated. When the threshold reference voltage VTH2 is lower by the voltage PV2 than the lowest value of the threshold voltage range, a low-level protection signal PS2 is generated. When the voltage PV2 is a value included between the highest value and the lowest value of the threshold voltage range, the protection signal PS2 does not experience level change.

According to another exemplary embodiment of the present invention, a current of an inductor L2 flows to a photodiode forming an opto-coupler rather than flowing to a resistor RP2.

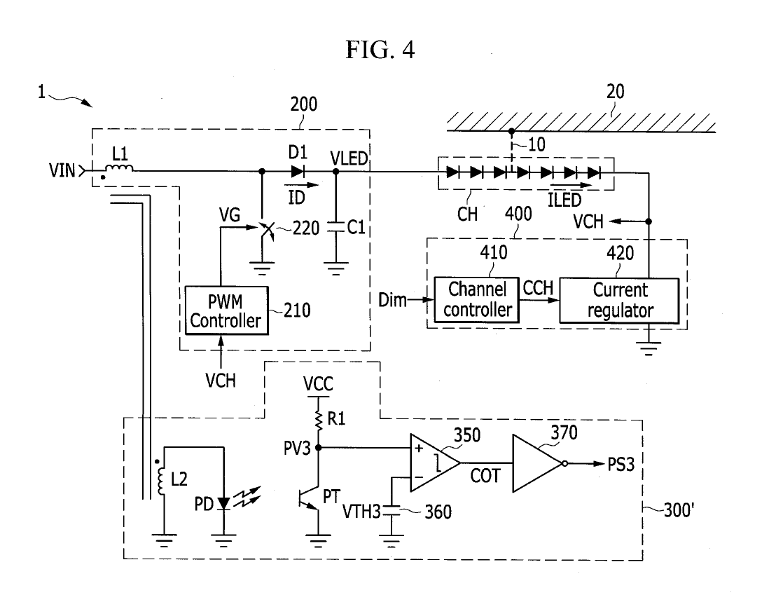

Referring to FIG. 4, another exemplary of the present invention will be described.

FIG. 4 shows an LED emitting device including a protection circuit according to another exemplary embodiment of the present invention. Parts that are the same as the previously described exemplary embodiment have the same reference numerals. Parts that are the same as the previously described exemplary embodiment will not be described.

As shown in FIG. 4, a protection circuit 300″ includes a photodiode PD connected to an inductor L2 rather than a resistor RP2 and a photo transistor TP forming an opto coupler together with the photodiode PD. The protection circuit 300″ includes a hysteresis comparator 350, a reference voltage source 360, an inverter 370, and a resistor R1.

The photodiode PD includes an anode connected to the inductor L2 and a cathode being grounded.

The phototransistor PT is opto-coupled to the photodiode PD, and a current corresponding to a light emission amount of the photodiode PD. The phototransistor PT is connected between one end of the resistor R1 and a ground, and the other end of resistor R1 is connected to a bias voltage VCC that activates the phototransistor PT.

The hysteresis comparator 350 includes a non-inversion terminal (+) to which a voltage PV3 generated according to a current flowing to the phototransistor PT and an inversion terminal (−) to which a threshold reference voltage VTH3 is input.

When a threshold reference voltage VTH3 is higher by a voltage PV3 than the highest value of a predetermined threshold voltage range determined according to a hysteresis characteristic of the hysteresis comparator 350, a high-level output signal COT is generated. When the threshold reference voltage VTH3 is lower by the voltage PV3 than the lowest value of the threshold voltage range, a low-level output signal COT is generated. When the voltage PV3 is a value included between the highest value and the lowest value of the threshold voltage range, the output signal COT does not experience level change.

The inverter 370 generates a protection signal PS3 by inverting the output signal COT. In the exemplary embodiments of the present invention, the protection operation is executed when the protection signal is in high level. Thus, an inverter 370 is added to generate a protection signal PS3 according to another exemplary embodiment of the present invention. However, when the protection operation is executed by the protection signal PS3 is low level, the inverter 370 is not necessary.

An excessive amount of current flows to the inductor L1 due to abnormal grounding of the LED channel CH and thus the amount of current flowing to the inductor L2 is increased, the light emission amount of the photodiode PD is increased and the amount of current flowing to the phototransistor PT is increased.

Then, a voltage drop due to the resistor R1 from the bias voltage VCC is increased, and accordingly the voltage PV3 is decreased. When the voltage PV3 is lower than the lowest value of the threshold voltage range, the hysteresis comparator 350 generates a low-level output signal COT and the low-level output signal OCT is inverted through the inverter 370 such that a high-level protection signal PS3 is generated.

The threshold reference voltage VTH3 may be set to sense a decrease of the voltage PV3 according to the current generated in the inductor L2 due to the abnormal grounding of the LED channel CH.

In the above-described exemplary embodiments of the present invention, the protection circuit was able to sense the abnormal grounding of the LED channel CH. Even though the LED channel is provided in plural, the exemplary embodiments still can be applicable with modification of the values of the threshold reference voltages VTH1 to VTH3.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, it will be appreciated to those skilled in the art that various modifications are made and other equivalent embodiments are available. Accordingly, the actual scope of the present invention must be determined by the spirit of the appended claims.

### DESCRIPTION OF SYMBOLS

AC-DC converter 100, converter 200, protection circuit 300 channel driver 400, LED channel CH, inductor L1 and L2 PWM controller 210, switch 220, rectifying diode D1 capacitor C1, channel controller 410, current regulator 420 error amplifier 421, NMOSFET 422, resistor (RR, RP1, RP2, RP3, R1) hysteresis comparator 310, 330, and 350 reference voltage source 320, 340, and 360 photodiode PD, phototransistor PT, inverter 370

What is claimed is:

1. A light emitting diode (LED) emitting device having an LED channel formed of a plurality of LEDs connected in series and a ground adjacent to the LED channel, comprising:
a converter generating a voltage for activation of the LED channel by converting an input voltage; and
a protection circuit determining whether the LED channel is grounded by sensing a current flowing to the ground.

2. The LED emitting device of claim 1, wherein the protection circuit comprises:
a resistor having a first end connected to the ground and a second end connected to the other ground; and
a hysteresis comparator including a first input terminal connected to the first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic.

3. The LED emitting device of claim 2, wherein the threshold reference voltage is determined according to a voltage generated when the LED channel is connected to the ground and thus a current flowing to the ground flows to the resistor.

4. A light emitting diode (LED) emitting device having an LED channel formed of a plurality of LEDs connected in series and a ground adjacent to the LED channel, comprising:
a converter having a first inductor receiving an input voltage, and generating a voltage for activation of the LED channel by controlling switching operation of a switch that controls a current flowing to the first inductor; and
a protection circuit determining whether the LED channel is grounded by sensing a current flowing to a second inductor coupled to the first inductor in an insulated manner.

5. The LED emitting device of claim 4, wherein the protection circuit comprises:
a resistor connected in parallel to the second inductor; and
a hysteresis comparator comprising a first input terminal connected to a first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic.

6. The LED emitting device of claim 5, wherein the threshold reference voltage is determined according to a voltage generated when the LED channel is connected to the ground and thus a current flowing to the second inductor flows to the resistor.

7. The LED emitting device of claim 4, wherein the protection circuit comprises:
a photodiode coupled in parallel to the second inductor;
a phototransistor forming an opto coupler with the photodiode;
a resistor having a first end connected to the phototransistor and a second end connected to a predetermined bias voltage; and
a hysteresis comparator having a first input terminal connected with the first end of the resistor and a second input terminal to which a predetermined threshold reference voltage is input, and determining whether the LED channel is grounded by comparing a voltage of the first input terminal and a threshold reference range within which the threshold reference voltage is set according to a hysteresis characteristic.

8. The LED emitting device of claim 7, wherein the threshold reference voltage is determined according to a voltage drop that occurs by a current flowing to the phototransistor when the LED channel is connected to the ground and thus the current flowing to the second inductor flows to the photodiode.
